(19) United States
(12) Patent Application Publication
(10) Pub. No.: US 2021/0032914 A1
(43) Pub. Date: Feb. 4, 2021

(54) MOTOR VEHICLE DOOR HANDLE ARRANGMENT WITH POTTED ELECTRONICS

(71) Applicant: HUF HULSBECK & FURST GMBH & CO. KG, Velbert (DE)

(72) Inventors: Michael KALESSE, Ratingen (DE); Mirko SCHINDLER, Velbert (DE); Peter VAN GASTEL, Solingen (DE); Andreas GORNIK, Bochum (DE)

(73) Assignee: HUF HULSBECK & FURST GMBH & CO. KG, Velbert (DE)

(21) Appl. No.: 16/641,046

(22) PCT Filed: Aug. 28, 2018
(86) PCT No.: PCT/EP2018/000416

§ 371 Date: Feb. 21, 2020

(30) Foreign Application Priority Data
Sep. 5, 2017 (DE) 10 2017 008 340.1

(51) Int. Cl. E05B 85/16; B60R 16/023; E05B 81/78; H01Q 7/08; H01Q 1/32; H01Q 1/40

(52) U.S. Cl. CPC E05B 85/16; B60R 16/0231; E05B 81/78; B62D 65/00; H01Q 1/3283; H01Q 1/40; H01Q 1/3241; H01Q 7/08

(57) ABSTRACT

A motor vehicle door handle arrangement includes a handle support and an outer shell which is fastened to the handle support. At least one electronics assembly comprising electronic components is arranged between the handle support and the outer shell. The handle support has at least one first chamber for receiving electronic components which are potted with a potting compound after the electronic components are inserted. A second chamber for receiving electronic components is formed between the handle support and the outer shell and the handle support has at least one aperture through which the second chamber can be filled with potting compound after the outer shell is fastened to the handle support. A method for producing a motor vehicle door handle arrangement of this kind is disclosed.

The invention relates to a motor vehicle door handle arrangement according to the preamble of claim 1. The invention furthermore relates to a method for producing and mounting a motor vehicle door handle arrangement of this kind.

Motor vehicle door handle arrangements of this kind, comprising a handle for actuating the door of a motor vehicle are known. It is furthermore known to arrange electronic components, such as an antenna, a coil that is wound around the antenna and is intended for automatically establishing a radio link to an external identifier and/or sensors, in the handle. The terms winding and coil are used synonymously. In order to protect the electronic components against environmental influences, the installation space provided for the electronic components is potted using a potting compound, following insertion of the electronic components.

The object of the invention is that of specifying a motor vehicle door handle arrangement in which there is greater flexibility in the arrangement of electronic components, together with good protection of the electronic components against external influences.

This object is achieved according to the invention by a motor vehicle door handle arrangement according to claim 1. Advantageous developments of the invention are specified in the dependent claims.

In the case of a the motor vehicle door handle arrangement comprising a handle support and an outer shell that is fastened to the handle support, wherein at least one electronics assembly comprising electronic components is arranged between the handle support and the outer shell, wherein the handle support comprises at least one first chamber that is intended for receiving electronic components and is potted using a potting compound following insertion of the electronic components, it is particularly advantageous for a second chamber for receiving the electronic components to be formed between the handle support and the outer shell, and for the handle support to comprise at least one opening through which the second chamber can be filled with potting compound after the outer shell has been fastened to the handle support.

Since a second chamber for receiving electronic components is formed between the handle support and the outer shell, the motor vehicle door handle arrangement has greater flexibility with respect to arranging electronic components. Since both the chambers for receiving electronic components, which chambers are formed between the handle support and the outer shell, are in each case potted with potting compound after the electronic components have been inserted into the two chambers, the electronic components in the chambers are reliably protected against moisture and against shocks and vibrations.

The manufacture is simplified in the process, because the handle support comprises at least one opening through which the second chamber can be filled with potting compound after the outer shell has been fastened to the handle support. As a result, a prefabricated electronics assembly comprising electronic components can first be inserted into the handle support, in the first chamber, and subsequently the first chamber can be potted using potting compound. Subsequently, the outer shell is mounted on the handle support, and the second chamber between the outer shell and handle support, in which further electronic components are enclosed following mounting of the outer shell, is subsequently filled with potting compound, through the opening in the handle support provided for this purpose.

The potting compound can be a curing potting compound which is reversibly deformable following curing, and is thus suitable for damping shocks and vibrations. As a result, the electronic components are reliably protected both against moisture and against shocks and vibrations.

Following mounting on the handle support and the installation of the motor vehicle door handle arrangement on a motor vehicle, the outer shell forms the outer cover and thus both an optical finish and protection against moisture and outside influences.

The electronics assembly particularly preferably comprises at least one antenna comprising a ferromagnetic core and a coil that is wound around the core, and at least one circuit board and/or a capacitive proximity sensor. In particular, the antenna can be located in the first chamber, and the circuit board and/or proximity sensor can be located in the second chamber.

Potting both the first chamber and the second chamber with potting compound, following insertion of the electronic components into the respective chambers means that the electronic components such as the circuit board, capacitive proximity sensor and the antenna, together with the winding thereof, are protected against moisture and vibrations. As a result, malfunctions and failures of the electronic components are reliably prevented.

The handle support and the outer shell are preferably form-fittingly interconnected.

The handle support and/or the outer shell may comprise undercuts behind which the mating part engages and which allow for coupling of the components by means of insertion at the first end, wherein the opposing end is subsequently pivoted towards the mating part, while being clipped into corresponding undercuts on the mating part. The mounting of the outer shell on the handle support can thus in particular be achieved in that a first end of the outer shell is pushed onto the handle support in such a way that fastening elements of the outer shell engage behind undercuts on the corresponding first end of the handle support. A rotational movement of the outer shell relative to the handle support is then performed, in that the second end of the outer shell is pivoted towards the handle support until undercuts on the second end of the handle support come into engagement with corresponding mating parts on the outer shell, and the outer shell is thus fastened to the handle support, at the second end, by means of clipping in. The undercuts on the first end and/or on the second end of the handle support and/or the fastening elements on the outer shell that correspond thereto can comprise starting chamfers in order to make it easier to place on and mount the outer shell.

The first chamber preferably comprises at least one recess in a wall for feeding through electrically conductive contact pins, wherein the electronics assembly comprises a connector which rests in the recess in the wall of the first chamber in a form-fitting and/or force-fitting manner, and so as to seal the first chamber.

In this case, the connector can be manufactured in particular by means of one-off or repeated plastic overmolding of prefabricated contact pins.

In this case, the contact pins are overmolded using plastics once or repeatedly and form a connector; in particular, in the case of plastic overmolding a second time a softer material can be used as the seal for the first and/or the second chamber. It is thus possible, in the case of a plurality of plastics injection processes, for the same plastics material or different plastics materials having different properties to be used. In the case of a first plastics injection process, it is thus possible to use a harder material for forming a stable connector. This preliminary stage can be overmolded using a softer plastics material in a second plastics injection process, as a result of which a seal is formed, on the outside, on the connector. Said seal of the connector serves in particular at least as the seal of the first chamber in the handle support. The sealing effect is achieved in that the connector rests in the recess in the wall of the antenna chamber in a form-fitting and/or force-fitting manner, and so as to seal the first chamber.

The outer shell preferably comprises a trough which forms the second chamber and in which a portion of the electronics assembly, in particular a circuit board and/or a capacitive proximity sensor, is located, wherein the trough comprises at least one recess in a wall for feeding through electrically conductive contact pins, and wherein a connector of the electronics assembly rests in the recess in the wall of the trough in a form-fitting and/or force-fitting manner, and so as to seal the trough.

In this case, the electronics assembly comprises a connector which rests in a recess in a wall of the second chamber in a form-fitting and/or force-fitting manner, and so as to seal the second chamber.

The electronics assembly preferably comprises a connector for feeding through electrical connection lines, wherein the connector comprises an antenna chamber groove on the outside, which groove forms a form-fitting connection with a recess in the wall of the first chamber, in the handle support.

The electronics assembly preferably comprises a connector for feeding through electrical connection lines, wherein the connector comprises a trough groove on the outside, which groove forms a form-fitting connection with a recess in the wall of a trough, in the outer shell, that forms the second chamber.

The electronics assembly particularly preferably comprises a connector for feeding through electrical connection lines, wherein the connector comprises an antenna chamber groove on the outside, which groove forms a form-fitting connection with the recess in the wall of the first chamber, in the handle support, and wherein the connector comprises a trough groove on the outside, which groove forms a form-fitting connection with a recess in the wall of a trough, in the outer shell, order to forms the second chamber, wherein the antenna chamber groove and the trough groove are arranged opposingly.

In particular, the connector of the electronics assembly can comprise an outer contour having one or more recesses and/or grooves and/or projections which furthermore function as positioning aids when inserting the connector, in particular together with an antenna support that is optionally formed in one piece and in particular integrally with the connector, into the first chamber, and interact with corresponding mating parts on the contour of the wall of the first chamber.

Furthermore, the connector and an antenna support may be formed in one piece, in particular integrally. The connector and antenna support can thus be manufactured in one piece, and in particular integrally, by means of a first plastics injection process. In turn, in a second plastics injection process, a seal consisting of an in particular softer plastics material may be injected onto said component.

Accordingly, the contact pins may be overmolded with plastics material and form a connector, wherein the connector and the antenna support are formed in one piece, in particular integrally. The connector is preferably manufactured by means of repeated plastics overmolding of prefabricated contact pins, wherein a plastics material forming a flexible seal is used in the final plastics injection process. As explained, the connector particularly preferably comprises a first groove on the outside, which groove forms a form-fitting connection with the recess of the wall of the first chamber, wherein the connector may further comprise a second groove that opposes the first groove and which forms a form-fitting connection with a recess in the wall of the trough that forms the second chamber.

It is particularly advantageous, in this case, for the connector formed on the antenna support to act as a positioning aid when inserting the antenna support into the first chamber, and for the form-fitting connection between the connector and the opening in the wall of the first chamber to be achieved at the same time as the module is inserted into the handle support. The opening in the wall is used for feeding through the electrical connections from the antenna to the circuit board, which is located in the second chamber following successful mounting. As a result of the opposingly oriented second groove on the outer face of the connector, the connector furthermore automatically comes into engagement with the opening in the wall of the trough, on the outer shell, that forms the second chamber, and forms a second form-fitting connection, when the outer shell is mounted on the handle support. After the electronics assembly has been inserted into the handle support, the antenna chamber groove comes into engagement, already in a sealing manner, on the first chamber. As a result of the opposing arrangement, the trough groove automatically comes into engagement on the second chamber in a sealing manner, when the outer shell is placed on.

As a result, an antenna support that receives the antenna, comprising a one-piece or multi-part ferromagnetic core and a coil wound around the core, can be located in the first chamber. Furthermore, the antenna support can receive at least one sensor plate of a capacitive proximity sensor; in particular, the sensor plate of a capacitive proximity sensor may be located in a form-fitting manner in the antenna support.

The method for producing a motor vehicle door handle arrangement of this kind comprises the steps of:
inserting a prefabricated electronics assembly into a handle support and inserting at least a portion of the electronics assembly into a first chamber in the handle support;
potting the first chamber using potting compound;
placing the outer shell on the handle support, and fastening the outer shell onto the handle support, as a result of which a portion of the electronics assembly is inserted into a second chamber, in the outer shell, at the same time;
rotating the motor vehicle door handle arrangement by 180° about a longitudinal axis of the motor vehicle door handle arrangement, such that the outer shell is located at the bottom;
potting the second chamber, with potting compound, through at least one through-opening in the handle support.

Within this meaning, the longitudinal axis extends in parallel with the axis of the ferromagnetic core of the antenna and with the longitudinal axis of the winding of the antenna that surrounds the ferromagnetic core. For each procedure of potting the chambers with potting compound, the partially mounted motor vehicle door handle arrangement is in each case positioned such that the potting compound can be poured, vertically from above, into the chamber to be potted in each case. For the purpose of filling the second chamber with potting compound, the handle support comprises at least one opening through which the potting compound can be introduced into the second chamber. Said opening in the handle support thus serves as a filling opening for the potting compound when potting the second chamber.

When inserting the prefabricated electronics assembly into the handle support and inserting at least a portion of the electronics assembly into a first chamber in the handle support, it is particularly preferable for a connector of the electronics module to be brought into engagement with a recess in a wall of the first chamber in a form-fitting and/or force-fitting, and in particular sealing, manner.

When placing the outer shell on the handle support and fastening the outer shell onto the handle support, as a result of which a portion of the electronics assembly is inserted into the second chamber, in the outer shell, at the same time, it is particularly preferable for a connector of the electronics assembly to be brought into engagement with a recess in a wall of the second chamber in a form-fitting and/or force-fitting, and in particular sealing, manner.

The handle support and the outer shell preferably comprise undercuts and/or guides, behind which the mating part engages, and wherein the placing and fastening of the outer shell on the handle support is achieved by means of pushing in, at the first end, behind the guides on the handle support, wherein the opposing end of the outer shell is subsequently pivoted towards the handle support until a latching hook has been clipped into a lug on the mating part.

An embodiment of the invention is shown in the figures and explained in the following. In the figures:

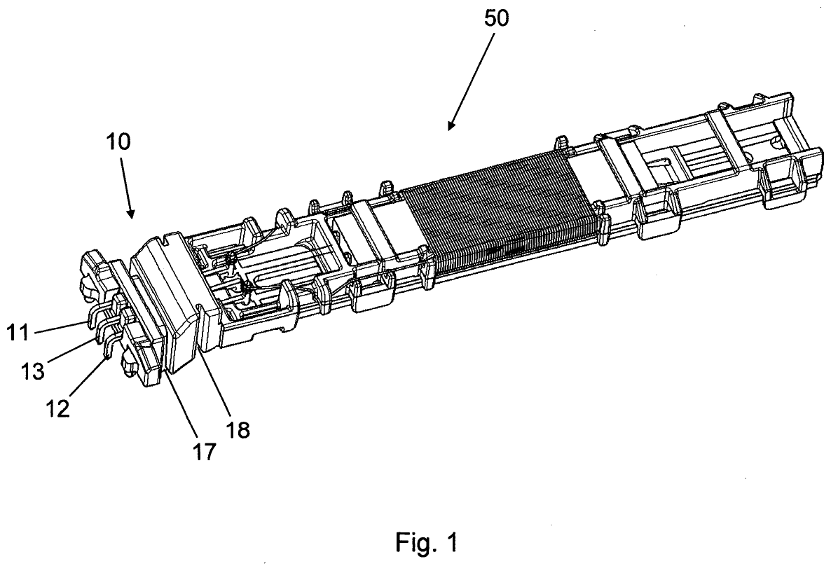

FIG. 1 shows a pre-mounted antenna support comprising a winding and connector;

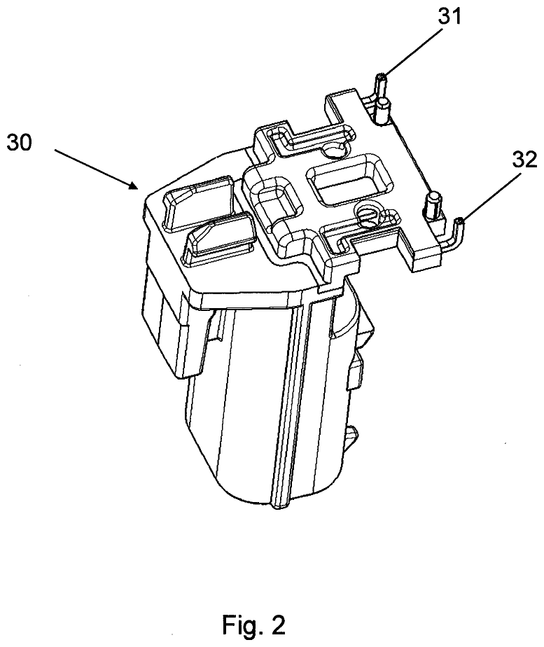

FIG. 2 shows a plug comprising contacts for connection to a circuit board;

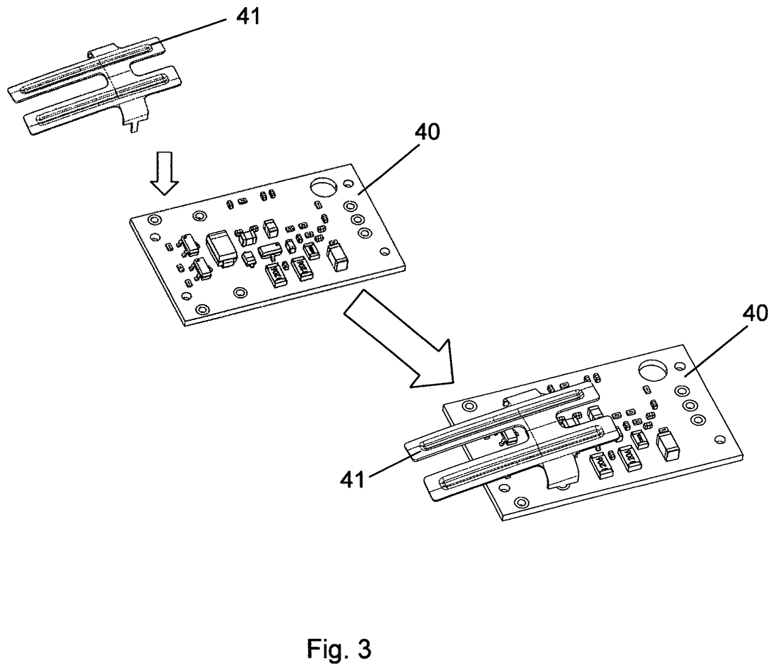

FIG. 3 shows the circuit board of the electronics assembly, and the mounting of a sensor plate on the circuit board;

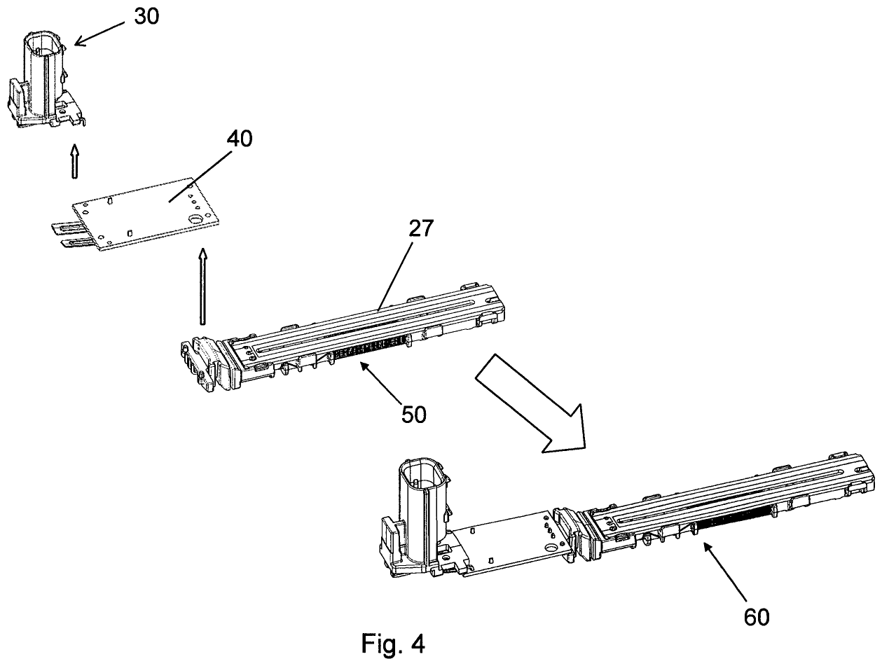

FIG. 4 shows the manufacture of the electronics assembly by mounting the plug and the antenna support, comprising the connector, on the circuit board;

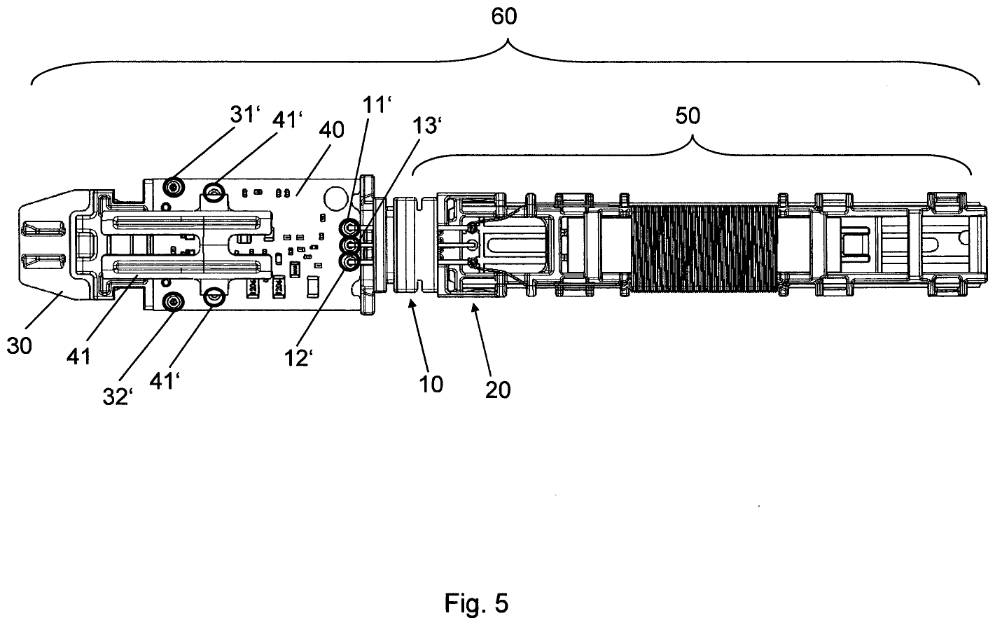

FIG. 5 shows the underside of the electronics assembly, comprising the soldering points for soldering the contacts to the circuit board;

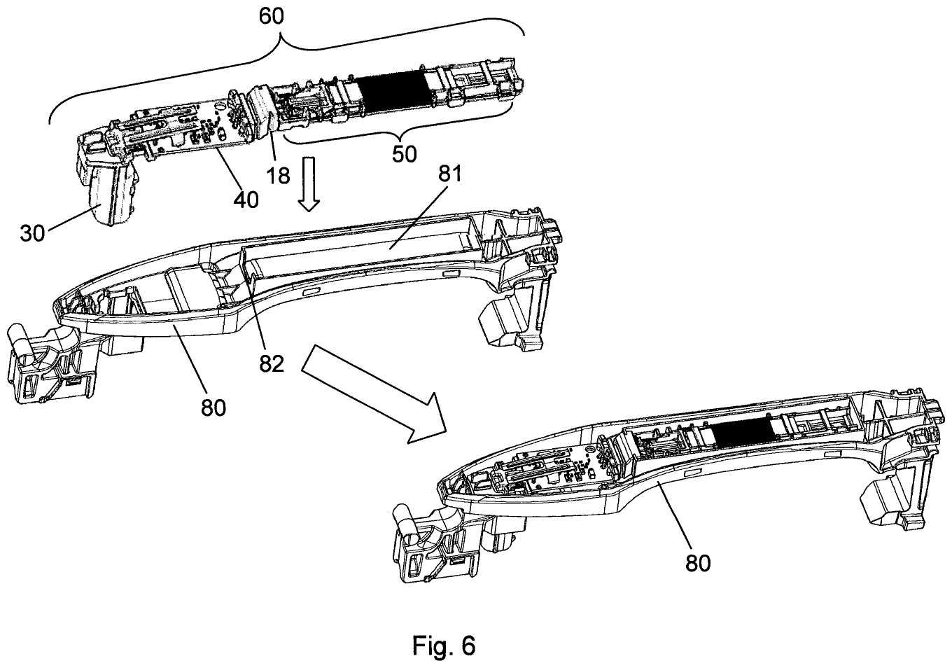

FIG. 6 shows the insertion of the electronics assembly into the handle support;

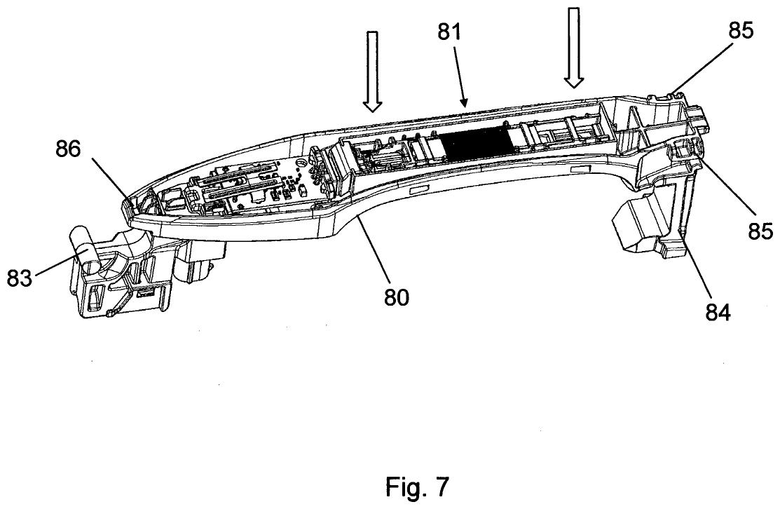

FIG. 7 shows the potting process when potting the first chamber using potting compound;

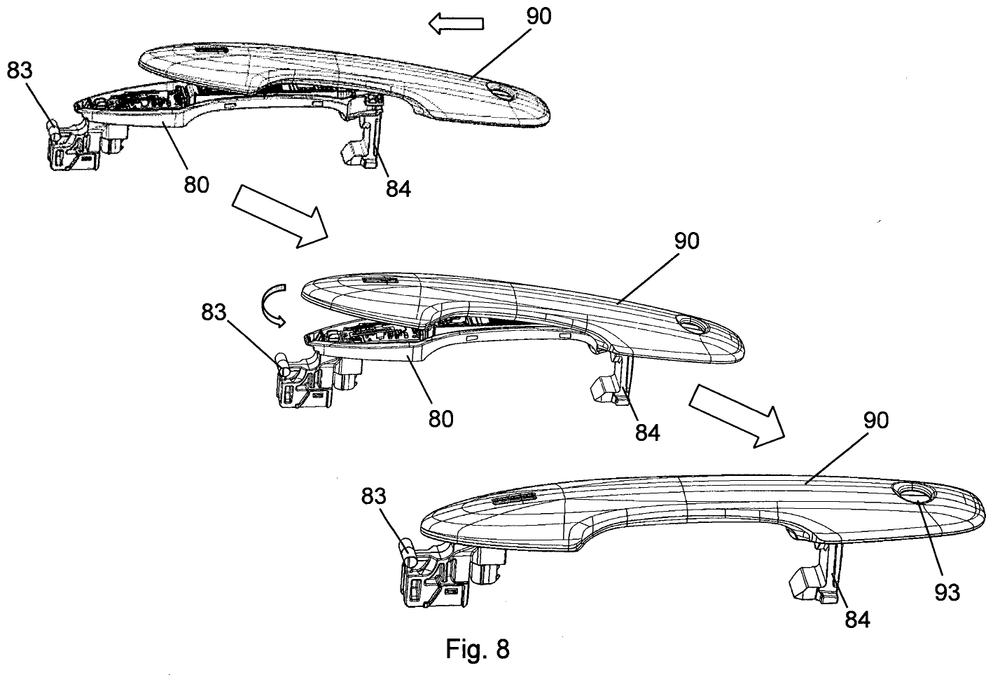

FIG. 8 shows the process of mounting the outer shell on the handle support;

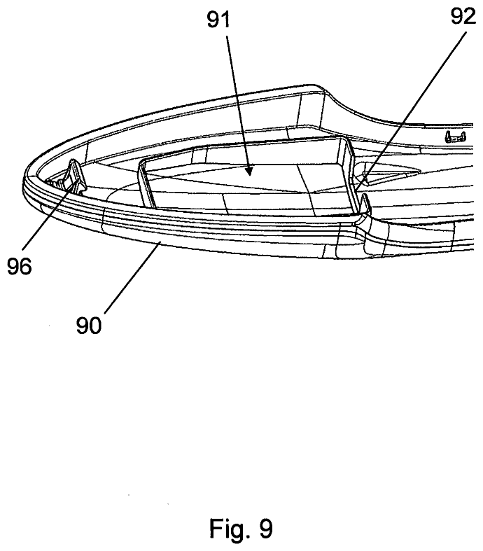

FIG. 9 is a view of an enlarged detail of the inside of the outer shell;

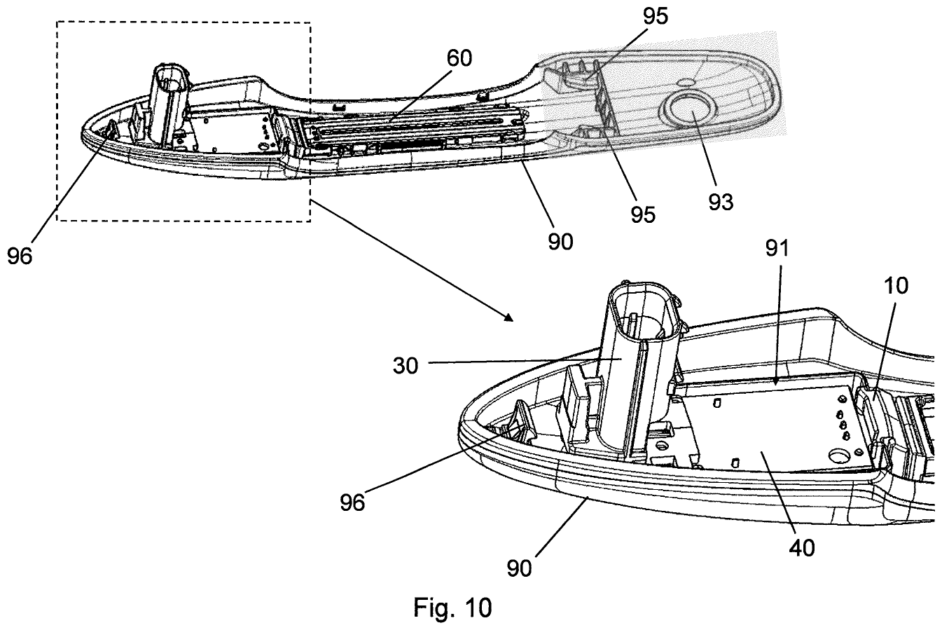

FIG. 10 shows the view of the inside of the outer shell comprising an electronics assembly located therein, and an enlarged detail;

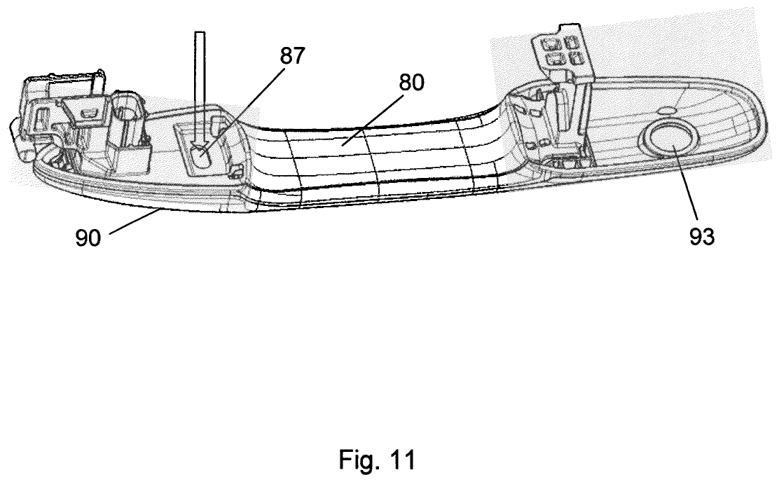

FIG. 11 shows the potting process when potting the second chamber using potting compound.

The mounting and manufacturing process for manufacturing a motor vehicle door handle arrangement of this kind will be explained, at the same time, on the basis of the following description of the figures.

FIG. 1 shows a pre-mounted antenna module 50 consisting of the antenna support 20 and the connector 10 fastened thereto. The connector 10 is manufactured by means of plastics overmolding of the contact pins 11, 12, 13. The contact pins 11, 12, 13 are used for establishing the electrical connection of the antenna to a circuit board. On the outside thereof, the connector 10 comprises two grooves 17, 18, which each span three outer faces. In this case, the two grooves 17, 18, which each span three outer faces, are oriented opposingly. Said grooves 17, 18 form sealing regions. In this case the grooves 17, 18 for seals which interact with chambers, in which electronic components of the motor vehicle door handle arrangement are located, and seal said chambers. The mounting and operating principle will be explained below. In the embodiment shown according to FIG. 1, the overmolding of the contact pins 11, 12, 13 is performed in two steps, using different types of plastics materials. In this case, a harder plastics material is used for producing a preliminary stage. In order to produce the complete connector 10 in the second plastics injection process, a softer plastics material is used, which material is suitable for serving as a sealing element and which is thus more deformable than the plastics material of the preliminary stage.

In an alternative that is not shown, the connector 10 is produced in a single plastics injection process, using a plastics material that is suitable as a sealing element. In this case, in the single plastics injection process the contact pins 11, 12, 13 are overmolded using the plastics material that is suitable as the seal.

The contact pins 11, 12, 13 are used for coupling the antenna and a sensor plate of a capacitive proximity sensor, located in the antenna support 20, to the electronics of the motor vehicle door handle, and are soldered to terminals of the antenna and of the sensor plate. Furthermore, the ferromagnetic core 21 of the antenna, located in the antenna support, and the winding 26 surrounding the core 21, can be seen in FIG. 1. The ferromagnetic core 21 is located in the antenna support 20 in a form-fitting manner. The antenna support 20 is a plastics injection molded part. The ferromagnetic core 21 may be formed in one piece or in multiple parts. The winding 26 is wound around the antenna support 20, and thus simultaneously around the ferromagnetic core 21 located in the antenna support 20. In addition to the ferromagnetic core 21 and the winding 26, the antenna support 20 receives a sensor plate of a capacitive proximity sensor, which is not visible in the perspective view according to FIG. 1. The sensor plate 27 of the capacitive proximity sensor can be seen in FIG. 4, which figure shows the antenna assembly 50 in a different view. The sensor plate 27 of the capacitive proximity sensor is located in the antenna support 20 in a form-fitting manner. The sensor plate is pushed into grooves in the antenna support 20, wherein the grooves are positioned such that the sensor plate is located outside the winding 26 of the antenna and so as to be in parallel with the ferromagnetic core 21 of the antenna. Therefore, only the ferromagnetic core 21 of the antenna and the portion of the antenna support 20 carrying the winding are located inside the winding 26.

The connector 10 and antenna support 20 can alternatively also be manufactured in one piece and integrally, by means of plastics overmolding of the contact pins 11, 12, 13.

In this case, the antenna of the antenna assembly 50 is used for receiving remote control signals for remote control of the closure system by a user, and for forwarding the corresponding radio signals to the electronics on the circuit board 40 according to FIG. 3. The sensor plate of the capacitive proximity sensor is used for detecting a user gripping behind the handle, in order to thereby activate the electronics of the motor vehicle door handle arrangement.

For the purpose of coupling the electronics of the motor vehicle door handle arrangement to the motor vehicle a plug 30 is provided, which is shown in FIG. 2. The plug 30 is manufactured by means of one-off or repeated plastics overmolding of the contact pins 31, 32. The contact pins 31, 32 of the plug 30 are used for coupling the electronics of the motor vehicle door handle to the vehicle electronics.

FIG. 3 shows the circuit board 40 of the motor vehicle door handle arrangement that is equipped with electronics components. The equipped circuit board 40 is used for processing and forwarding the signals of the antenna and of the sensor plate, and for coupling to the vehicle electronics via the plug 30. Moreover, a further sensor plate that acts as a locking plate 41 is mounted on the circuit board 40 by means of being pushed onto the circuit board 40 from above, as is indicated by the arrow in FIG. 3. The circuit board 40 preassembled together with the locking plate 41 is shown in the bottom right-hand side of FIG. 3.

The process of mounting the plug 30 by means of placing the circuit board 40, from below, onto the contact pins 31, 32 of the plug 30, and furthermore the mounting of the preassembled antenna assembly 50 on the circuit board 40 by means of inserting the contact pins 11, 12, 13 of the connector 10 into corresponding holes in the circuit board 40 is shown in FIG. 4. The plug 30 is mounted in the circuit board 40 by means of inserting the contact pins 31, 32 of the plug 30 into the circuit board 40, in corresponding through-holes. The through-holes in the circuit board 40 form the electrically conductive contacts to the circuit board 40. The antenna assembly 50 is also mounted in the circuit board 40 by means of inserting the contact pins 11, 12, 13 of the connector 10 into the circuit board 40, in corresponding through-holes. The through-holes in the circuit board 40 form the electrically conductive contacts to the circuit board 40. As a result, the contact pins 31, 32 of the plug 30 are coupled to the circuit board 40, and furthermore the contact pins 11, 12, 13 of the antenna assembly 50 are coupled to the circuit board 40.

This results in the module 60 consisting of the antenna assembly 50 comprising the antenna and the winding, and the connector, the circuit board 40 and the plug 30 as is shown in FIG. 4. In this module 60, the circuit board 40 thus forms a carrier component for the electronics module 60.

FIG. 5 is a view from below of the electronics assembly 60, comprising the soldering points 11′, 12′, 13′, 31′, 32′, 41′ for connecting the contact pins 11, 12, 13, 31, 32 and the locking plate 41 to the circuit board 40. The soldering points 11′, 12′, 13′, 31′, 32′, 41′ are circled in FIG. 5. In this case, all the contact points are soldered to the circuit board 40 form the upper face of the circuit board 40, as is shown in FIG. 5. That is to say that the contact pins 11, 12, 13, 31, 32 are soldered to the circuit board 40 from the same side, although the plug 30 is inserted into the circuit board 40 from a different side from the antenna assembly 50 and the locking plate 41, as is shown in FIG. 4. Soldering all the contacts to the circuit board 40 from the same side simplifies the manufacture, because changing the side, and thus the need to rotate the module during the production process, is omitted. The process of soldering the contact points to the circuit board 40 completes the manufacturing process of the electronics module 60.

The electronics module 60 thus comprises the antenna support 20 which receives the antenna comprising the ferromagnetic core and the coil, as well as the sensor plate, and the connector 10 via which the electrically conductive contact pins are guided from the antenna and the sensor plate to the circuit board 40 equipped with the electronics components and are connected thereto, wherein the circuit board 40 is furthermore connected to the plug 30, which serves for establishing the electrical contacts for the electronics assembly of the module 60. In this case, the circuit board 40 forms a carrier component for the module 60.

FIG. 6 shows the insertion of the electronics module 60 into the handle support 80. The handle support 80 comprises a first chamber 81 which is used for receiving the antenna assembly 50 of the electronics module 60 and is therefore also referred to as an antenna chamber 81. The insertion is performed such that the antenna assembly 50 rests in the antenna chamber 81, in the handle support 80. The first chamber in the handle support 80, which acts as the antenna chamber 81, comprises a recess 82 in the wall thereof. The sealing of the antenna chamber 81 in the handle support 80 is achieved by means of the seal of the connector 10. The wall of the antenna chamber 81 comprises a recess 82 in which the connector 10 rests in a form-fitting and force-fitting manner, by means of the groove 18. The connector 10 comprises the groove 18, acting as the antenna chamber groove, on the outside thereof.

The wall of the antenna chamber 81 rests in a form-fitting manner in the groove 18 of the connector 10. At the same time, a clamping effect is achieved between the wall of the antenna chamber 81 and the connector 10. For this purpose, the connector 10 is formed, as explained above, of a reversibly deformable plastics material that is suitable as a seal. The antenna chamber groove 18 of the connector 10, and the recess 82 of the antenna chamber 81, are accordingly matched to one another. The antenna chamber 18 thus simultaneously forms a positioning aid when inserting the antenna assembly 50 of the electronics module 60 into the antenna chamber 81. The clamping effect of the seal 16 in the recess 82 of the wall of the antenna chamber 81 simultaneously secures and fixes the antenna assembly 50 against floating during the potting process described in the following. The potting compound cures after the potting process.

The circuit board 40 of the electronics module 60 rests in the handle support 80, outside the antenna chamber 81. The handle support 80 furthermore comprises a recess through which the plug 30 of the electronics module 60 passes.

Following insertion of the preassembled electronics assembly 60 into the handle support 80, the antenna chamber 81 is potted using potting compound, as is indicated in FIG. 7 by the arrows. Potting the antenna chamber 81 using potting compound protects the antenna assembly 50 from moisture and vibrations, since the potting compound cures in the antenna chamber 81. The potting compound thus forms watertight protection of the antenna assembly 50 and the soldered contacts against moisture. Furthermore, the potting compound serves as damping against vibrations.

The rotary axis 83 about which the entire motor vehicle door handle arrangement is rotatable, in the mounted state, can also be seen in FIG. 7. For this purpose the entire motor vehicle door handle arrangement is mounted in a corresponding receptacle in the body of a motor vehicle. Following the completion and finishing thereof as explained below, the completely mounted motor vehicle door handle arrangement is installed in a corresponding housing or directly in the motor vehicle body. The rotary axis 83 of the motor vehicle door handle arrangement is generally located at the front in the direction of travel, such that the gripping hook 84 can be pulled out to the outside of the motor vehicle, at the rear end of the motor vehicle door handle arrangement, and acts on the door lock via a corresponding coupling and allows for the motor vehicle door to be opened when the door lock is unlocked. The motor vehicle door handle arrangement can, however, be arranged as desired. In particular, this can also take place vice versa on the motor vehicle, or also vertically.

In order to mount the outer shell on the handle support 80, the handle support comprises horizontally extending guides 85 on both sides, at the right-hand end in FIG. 7 on which the gripping hook 84 is arranged, behind which guides corresponding mating parts in the form of undercuts 95 on the outer shell of the motor vehicle door handle arrangement still to be mounted can engage, and which are used for fixing the outer shell to the handle support 80. In this case, the definition according to which the guides 85 extend horizontally on the handle support 80 relates to the depiction of the handle support 80 according to FIG. 7 and not to the final installation position or orientation thereof following installation in a motor vehicle door. At the opposing end, the handle support comprises a lug 86 behind which a latching hook 96 on the corresponding end of the outer shell 90, to be mounded on the handle support 80, can engage and on which the outer shell 90 can be fixed by means of being clipped in, as will be explained in the following with reference to FIG. 8.

FIG. 8 shows the mounting of the outer shell 90 on the handle support 80. For this purpose, the outer shell 90 is pushed from the right-hand side, in the drawing plane according to FIG. 8, onto the guides 85 on the handle support 80, wherein, following displacement to the left in the drawing plane, corresponding undercuts 95 on the outer shell 90 engage behind the horizontally extending guides 85 on the handle support 80 and thus fix and secure the outer shell 90 on the handle support 80 in the vertical direction according to FIG. 8. In a second mounting step, the opposing free end of the outer shell 90 is pivoted, in a rotational movement, in the direction of the handle support 80 until the latching hook 96 of the outer shell 90 has latched in behind the lug 86 on the handle support 80. As a result, the outer shell 90 is fixed on the handle support 80.

FIG. 9 is a view of a detail of the inside of the outer shell 90. In the outer shell 90, a second chamber 91 for receiving electronic components is formed between the handle support 80 and the outer shell 90. Said second chamber 91 is used for receiving the circuit board 40 and the plug 30, and, by way of differentiation from the antenna chamber 81, is also referred to as the electronics chamber 91. The wall of the electronics chamber 91 comprises a recess 92 in which the connector 10 is located following mounting of the outer shell 90 on the handle support 80.

FIG. 10 shows the installation situation of the electronics assembly 60 in the outer shell 90 following assembly, but without the handle support, in FIG. 10, for the purpose of clearer illustration of the interaction between the second chamber 91 and the connector 10. The undercuts 95 on the inside of the outer shell, which engage behind the guides 85 on the handle support 80, in the installation situation, can also be seen in FIG. 10. A latching hook 96 is arranged on the opposing end of the outer shell 90, which hook latches behind the lug 86 on the handle support. For this purpose, the latching hook 96 can be reversibly deflected out of the rest position thereof and hook in behind the lug 86 on the handle support. In order to facilitate mounting, the latching hook 96 comprises a starting chamber.

The sealing of the second chamber 91 is achieved by means of the connector 10. The wall of the second chamber 91 comprises a recess 92 in which the connector 10 rests in a form-fitting and force-fitting manner by means of the groove 17. After the outer shell 80 has been mounted on the handle support, as explained above, the wall of the second chamber 91 rests in a form-fitting manner in the groove 17 of the connector 10. At the same time, a clamping effect is achieved between the wall of the second chamber 91 and the connector 10 which acts as a seal. For this purpose, the connector 10 is formed of a reversibly deformable plastics material that is suitable as a seal. The trough groove 17 of the connector 10, and the recess of the trough 70, are accordingly matched to one another.

When the left-hand end of outer shell 90, in the drawing according to FIG. 8, is pivoted towards the handle support 80, the recess 92 in the wall of the second chamber 91 and the trough groove 17 of the connector 10 are at the same time joined and slide inside one another. The trough groove 17 thus simultaneously forms a positioning aid when mounting the outer shell 90 on the handle support 80. As soon as the latching hook 96 of the outer shell 90 is latched in behind the lug 86 on the handle support 80, the form-fitting connection between the recess 92 in the wall of the second chamber 91 and the outside trough groove 17 on the connector 10 is also established at the same time. The trough groove 17 of the connector, which is oriented so as to be contrary to the antenna chamber groove 18, thus automatically comes into engagement with the recess 92 in the wall of the second chamber 91, which is formed in the outer shell 90, when the outer shell 80 is mounted.

In the embodiment shown, a latching hook 96 arranged on the outer shell 90 engages behind a lug 86 arranged on the handle support 80. In a further embodiment that is not shown, the arrangement of the lug and latching hook takes place in the kinematically opposite manner, in that a lug is arranged on the inside of the outer shell, behind which lug a latching hook arranged on the handle support engages.

FIG. 11 shows the potting process of the second chamber 91, denoted as the electronics chamber, together with the circuit board 40 located therein. In said potting process, the electronics chamber 91, together with the circuit board 40 located therein, is potted using curing potting compound. Said potting compound protects the electronics components of the circuit board 40 in the electronics chamber 91 and forms both a protection against moisture and at the same time a damping element against vibrations. In order to perform the second potting process, the entire preassembled motor vehicle door handle arrangement and that in the drawing plane according to FIGS. 8 and 11 is rotated by 180°, in order that the fluid potting compound can flow into the electronics chamber 91 from above. In order to allow for potting of the electronics chamber 91 using curing potting compound, the handle support 80 comprises an opening 87 as a filling opening, through which the potting compound is introduced into the electronics chamber 91, as shown by the arrow in FIG. 11, and the electronics chamber 91 can be completely filled with potting compound. The handle support thus comprises an opening 87, serving as a filling opening, through which the potting compound is introduced into the second chamber 91 during the second potting process.

The potting of the first chamber 81, which is also referred to as the antenna chamber, and of the second chamber 91, which is also referred to as the electronics chamber, thus takes place successively, at an orientation of the arrangement that is rotated by 180°.

Furthermore, the outer shell 90 comprises an opening 93 through which a key can be inserted into a lock (not shown in FIG. 11). In the installation situation, the door lock of the motor vehicle is located so as to be flush behind the opening 93 of the outer shell 90.

### LIST OF REFERENCE CHARACTERS

10 connector
11, 12, 13 contact pins
11′, 12′, 13′ soldering points
17 trough groove
18 antenna chamber groove
20 antenna support
21 ferromagnetic core
26 winding
27 sensor plate
30 plug
31, 32 contact pins
31′, 32′ soldering points
40 circuit board
41 locking plate
41′ soldering points
50 antenna assembly
60 electronics assembly
80 handle support
81 antenna chamber
82 recess in the wall of the first chamber
83 gripping hook
84 rotary axis
85 guides
86 lug
87 opening
90 outer shell
91 electronics chamber
92 recess in the wall of the second chamber
93 opening of the outer shell
95 undercuts
96 locking hook

1.-12. (canceled)

13. A motor vehicle door handle arrangement comprising a handle support and an outer shell that is fastened to the handle support, which is configured to receive at least one electronics assembly comprising electronic components between the handle support and the outer shell, wherein the handle support comprises at least one first chamber that is configured to receive electronic components and to be potted using a potting compound following insertion of electronic components, and a second chamber which is configured to receive electronic components and is formed between the handle support and the outer shell, and the handle support comprises at least one opening through which the second chamber is configured to be filled with potting compound after the outer shell has been fastened to the handle support.

14. The motor vehicle door handle arrangement according to claim 13, wherein the electronics assembly comprises at least one antenna having a ferromagnetic core and a coil that is wound around the core, and at least one circuit board and/or one capacitive proximity sensor, in particular in that the antenna is located in the first chamber and the circuit board and/or the proximity sensor is/are located in the second chamber.

15. The motor vehicle door handle arrangement according to claim 13, wherein the handle support and the outer shell are form-fittingly interconnected.

16. The motor vehicle door handle arrangement according to claim 13, wherein the first chamber comprises at least one recess in a wall for feeding through electrically conductive contact pins, and wherein the electronics assembly comprises a connector which rests in the recess of the wall of the first chamber in a form-fitting and/or force-fitting manner and so as to seal the first chamber.

17. The motor vehicle door handle arrangement according to claim 13, wherein the outer shell comprises a trough which forms the second chamber and in which a portion of the electronics assembly, in particular a circuit board and/or a capacitive proximity sensor, is configured to be located, wherein the trough comprises at least one recess in a wall for feeding through electrically conductive contact pins, and wherein a connector of the electronics assembly rests in the recess of the wall of the trough in a form-fitting and/or force-fitting manner and so as to seal the trough.

18. The motor vehicle door handle arrangement according to claim 13, wherein the electronics assembly comprises a connector for feeding through electrical connection lines, wherein the connector comprises an antenna chamber groove on the outside, which groove forms a form-fitting connection with a recess in the wall of the first chamber, in the handle support.

19. The motor vehicle door handle arrangement according to claim 13, wherein the electronics assembly comprises a connector for feeding through electrical connection lines, wherein the connector comprises a trough groove on the outside, which groove forms a form-fitting connection with a recess in the wall of a trough, in the outer shell, that forms the second chamber.

20. The motor vehicle door handle arrangement according to claim 13, wherein the electronics assembly comprises a connector for feeding through electrical connection lines, wherein the connector comprises an antenna chamber groove on the outside, which groove forms a form-fitting connection with a recess in the wall of the first chamber, in the handle support, and wherein the connector comprises a trough groove on the outside, which groove forms a form-fitting connection with a recess in the wall of a trough, in the outer shell, for forming the second chamber, wherein the antenna chamber groove and the trough groove are arranged opposingly.

21. A method for manufacturing a motor vehicle door handle arrangement comprising the following steps:
inserting a prefabricated electronics assembly into a handle support and inserting at least a portion of the electronics assembly into a first chamber in the handle support;
potting the first chamber using potting compound;
placing an outer shell on the handle support, and fastening the outer shell onto the handle support, as a result of which a portion of the electronics assembly is inserted into a second chamber, in the outer shell, at the same time;
rotating the motor vehicle door handle arrangement by 180° about a longitudinal axis of the motor vehicle door handle arrangement, such that the outer shell is located at the bottom; and
potting the second chamber, with potting compound, through at least one through-opening in the handle support.

22. The method according to claim 21, wherein when inserting the prefabricated electronics assembly into the handle support and inserting at least a portion of the electronics assembly into a first chamber in the handle support, a connector of the electronics module is brought into engagement with a recess in a wall of the first chamber in a form-fitting and/or force-fitting, and in particular sealing, manner.

23. The method according to claim 21, wherein when placing the outer shell on the handle support and fastening the outer shell onto the handle support, as a result of which a portion of the electronics assembly is inserted into the second chamber, in the outer shell, at the same time, a connector of the electronics assembly is brought into engagement with a recess in a wall of the second chamber in a form-fitting and/or force-fitting, and in particular sealing, manner.

24. The method according to claim 21, wherein the handle support and the outer shell comprise undercuts and/or guides, behind which the mating part engages, and wherein the placing and fastening of the outer shell on the handle support is achieved by means of pushing in, at the first end, behind the guides on the handle support, wherein the opposing end of the outer shell is subsequently pivoted towards the handle support until a latching hook has been clipped into a lug on the mating part.
